(19) United States
(12) Patent Application Publication
(10) Pub. No.: US 2024/0181294 A1
(43) Pub. Date: Jun. 6, 2024

(54) Method and System To Track Pitches

(71) Applicant: Joanna Mangum, Elm Grove, LA (US)

(72) Inventor: Joanna Mangum, Elm Grove, LA (US)

(21) Appl. No.: 18/530,176

(22) Filed: Dec. 5, 2023

Related U.S. Application Data
(60) Provisional application No. 63/386,171, filed on Dec. 5, 2022.

(51) Int. Cl. A63B 24/00

(52) U.S. Cl. CPC A63B 24/0062; A63B 24/0006

(57) ABSTRACT

The invention includes a system and a method of tracking pitches in a baseball or softball setting where for each pitch, the pitch location is identified by the user, the pitch type is identified by the user, and the pitch results are entered in an electronic database. The system has two operating modes: a practice session where a pitcher practices his pitches, and a game mode where the pitcher is pitching to team batters, with the game organized into innings. The results of pitches can be displayed, allowing the user to track the pitches to assist the pitcher with his pitching techniques and, in game mode, to help the user select the next pitch thrown to a batter.

### PRIORITY CLAIM

This application claims the priority benefit of provisional patent application 63/386,171, filed on Dec. 5, 2022.

### BACKGROUND OF THE SYSTEM

Pitchers are trained to pitch certain pitches by coaches teaching the fundamentals of a pitch, such as finger position and throwing motion, and then having the pitcher practice throwing the pitch. However, tools are needed to help the coach track pitches in real time to help a pitcher with their pitching technique or to select pitches in a game environment.

### SUMMARY OF THE INVENTION

The invention includes a system and a method of tracking pitches in a baseball or softball setting where for each pitch, the pitch location is identified by the user, the pitch type is identified by the user, and the pitch results are all entered into an electronic database. The system has two operating modes: a practice session mode where a pitcher practices his pitches, and a game mode where the pitcher is pitching to team batters, with the game organized into innings. The results of game pitches can be displayed, allowing the user to track the pitches to assist the pitcher with his pitching techniques to improve pitch location and pitch type and to help the user select the next pitch to a batter in a game mode.

### BRIEF DESCRIPTION OF THE FIGURES

FIG. 1 is a screenshot showing the dashboard with selectable options.

FIG. 2 is a screenshot in the practice mode where a pitcher is selected for the practice.

FIG. 3 is a screenshot where the practice is defined.

FIG. 4A is a screenshot showing the details of all the pitches by the selected pitcher in the selected practice. The pitch location details are shown in a bare strike zone box.

FIG. 4B is a screenshot showing the details of all the fastball pitches by the selected pitcher in the selected practice. The pitch location details are shown in a bare strike zone box.

FIG. 4C is a screenshot showing the details of all the curveball pitches by the selected pitcher in the selected practice. The pitch location details are shown in a bare strike zone box.

FIG. 5 is a screenshot showing the details of the pitches by the selected pitcher in the selected practice. The pitch details include pitch type and pitch result, shown on a list.

FIG. 6 is a screenshot showing the strike zone in a batter setting, where the user will record the pitch location. There are two strike zones that can be selected, either softball or baseball. In this embodiment, the strike zone is portioned into nine areas.

FIG. 7 is the pitch selection menu.

FIG. 8 depicts the displayed screenshot for entry of the details of a new game.

FIG. 9 depicts the screenshot of the new team menu for entry of the details of a new team.

FIG. 10 is a screen where the game selection is entered to start the game mode.

FIG. 11 is a screenshot of the batter's strike zone and a history of prior pitches made in the current inning.

FIG. 12 is a screenshot of the menu for pitch result.

FIG. 13 is a screenshot of the hit selection menu.

FIG. 14 is a screenshot of a schematic of the field of play.

FIG. 15 is the same figure as FIG. 11, with an added middle column showing pitch results for prior pitches made to the current batter, where pitch location is shown in a bare strike zone box.

FIG. 16 is a screenshot of a game summary, showing the details of all pitches made in the game, where pitch location is shown in a bare strike zone box.

### DETAILED DESCRIPTION OF THE INVENTION

The Counterpitch system includes a user terminal, such as a laptop, a tablet, or a smart phone, and the application software and associated databases and tables. The user terminal includes a visual display to display aspects of the application software to the user and to accept inputs and data from the user for transmission to the application software. The software may be used in a client server-based system, where the software is loaded on a server and accessed by the user terminal (the client) mover the internet; alternatively, the software application may load and run only on the user terminal device (not preferred).

The system is used in the softball and baseball industries to track pitches, to assist in pitcher performance, and may also be used to help a coach determine optimal pitch strategy in a game mode. Each team coach using the software will have a team database that may only be accessed by the team coach or by users that have permission to access the data stored in the team databases. The software, when operated in practice mode, can help determine if the pitcher is progressing in accuracy from session to session as she should be with each pitch type. From the application outputs, the coach can determine issues in the pitcher's pitching technique that need to be addressed to improve pitch placement. The stored data on pitch accuracy of a pitcher by pitch type can be used in real-time to help a coach determine pitch strategy during a game. The game mode of the application can be used by a coach to track the performance of the pitcher in an actual game by tracking each pitch for accuracy of pitch type and pitch placement. The game mode will specify for each pitch where the pitch crossed the plate, the type of pitch, and the results of the pitch. If the pitch results in a hit, the user may indicate where the hit landed in the field and optionally, which position on the pitching team interacted with the hit. The coach may also use the game mode to track how his team's players are interacting with the opponent's pitcher, pitch by pitch.

### Practice Mode

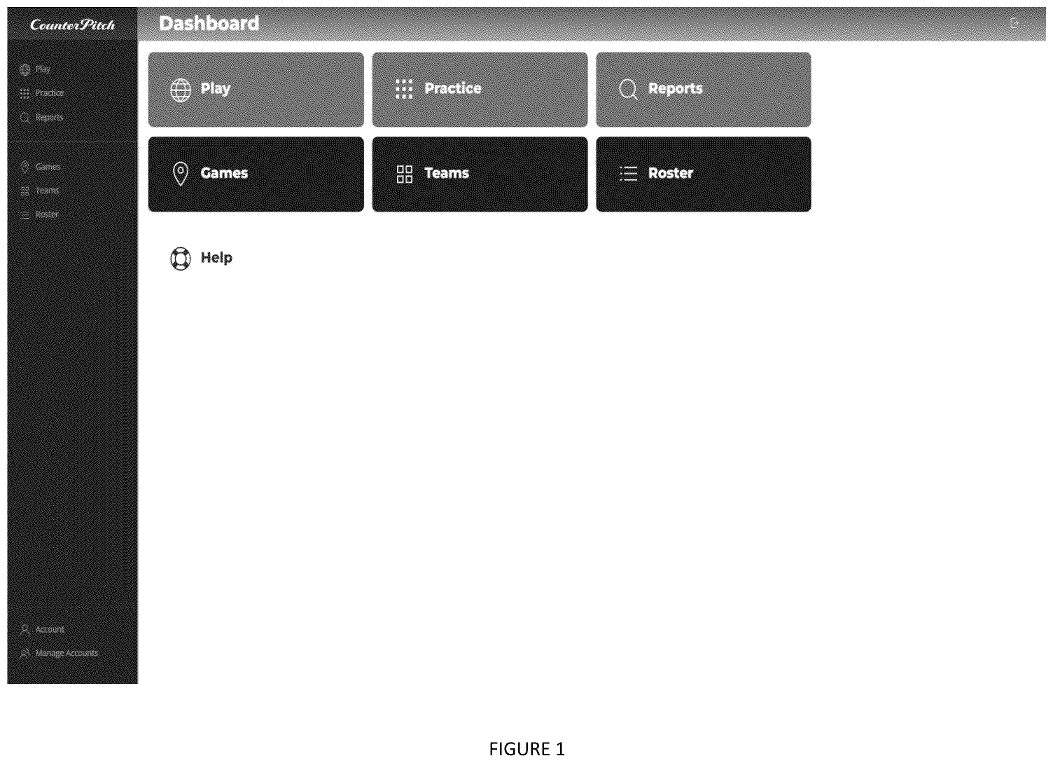

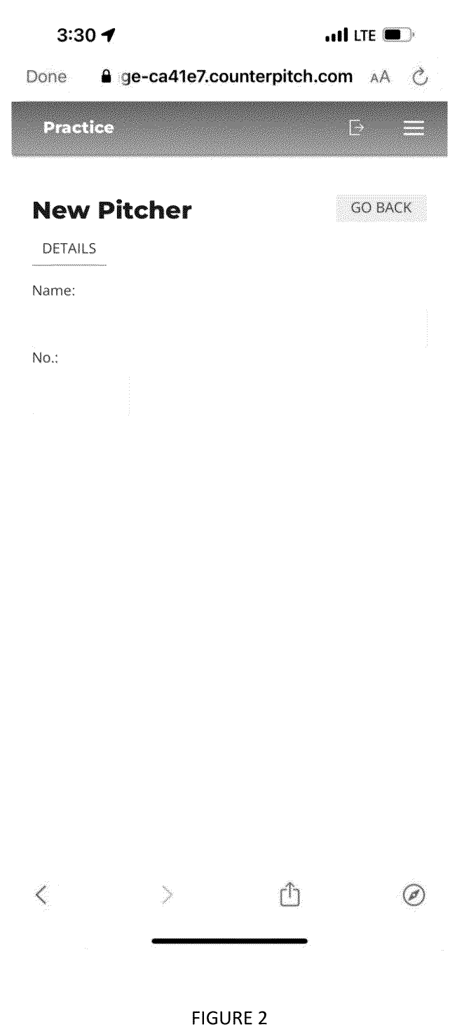

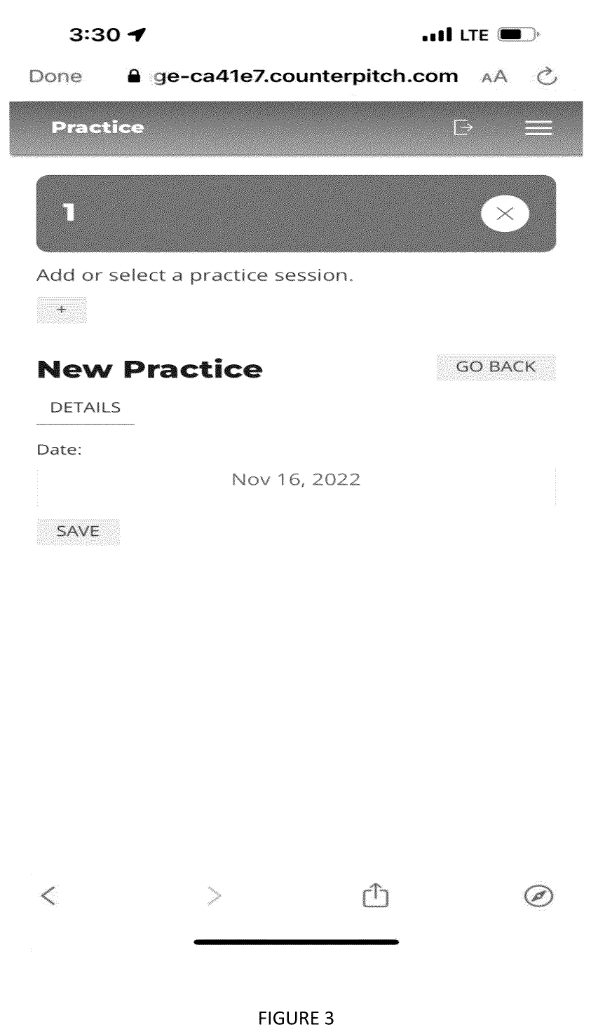

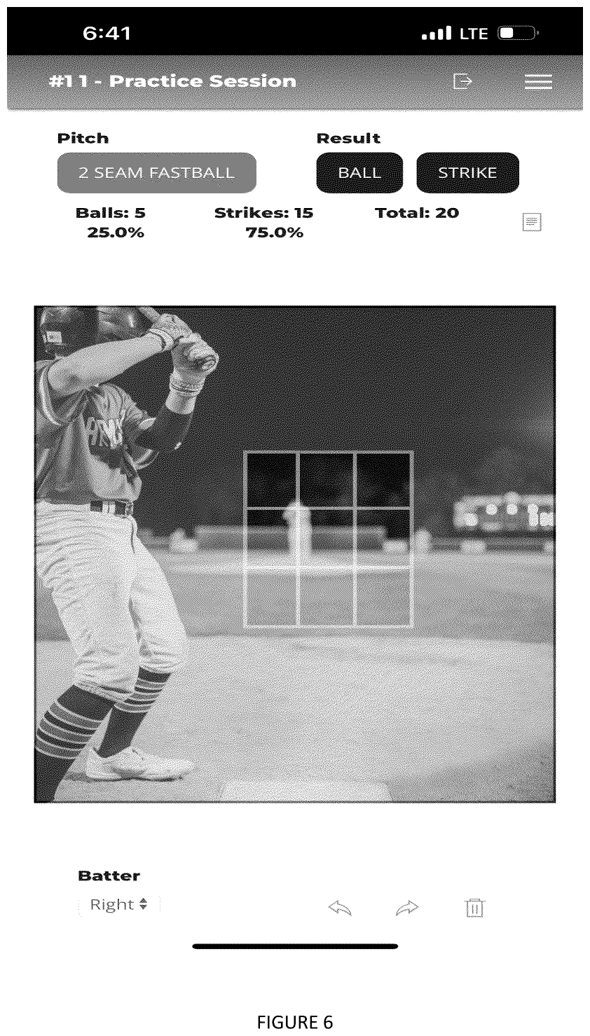

Practice Mode is run while pitchers are practicing their pitching skills to help coaches evaluate the pitchers' performance progress. To operate, the user (typically a pitching coach) will login to the system, using a user ID and password specific to him/her. Once logged in, the system dashboard will be displayed on the user's display, as shown in FIG. 1. As shown, the dashboard presents several options: Practice, Game, Teams, Roster, and Play, and a Reports button. The Practice button is where the details of the practice session are entered. The stored pitch statistics from the session can also be accessed from this function in real time, allowing pitcher performance to be tracked in a “practice” session in real time. FIG. 3 shows the Practice screen where the user enters details of the practice session to identify the session, such as date of session, pitcher (selected from the team roster), or for a new pitcher, by selecting creating a new pitcher in the team Roster page. See FIG. 2. As shown in this figure, a new pitcher not on the roster has been selected, and details of the new pitcher are entered on the page (name, handedness, jersey number). This page can also be used to add a new pitcher to the coach's team roster. The coach will then select the date for the practice session. Once the details of the practice session have been selected, when the session is to begin, the user will hit the start button from the dashboard and identify the practice session to start, and the system will initiate the practice session. Once started, the batter's strike zone page will automatically be displayed as shown in FIG. 6. The coach will have the sequence of pitches to be thrown by the pitcher—usually the same type of pitch, but it can be otherwise. The pitching coach can select the type of pitch (e.g., fastball) and can optionally select the desired pitch location (e.g., low, and inside), for the pitcher to practice his pitching technique for pitch placement and accuracy. A single pitch type can be selected, or a series of pitches selected for sequential pitches. The coach can modify the pitch sequence going forward.

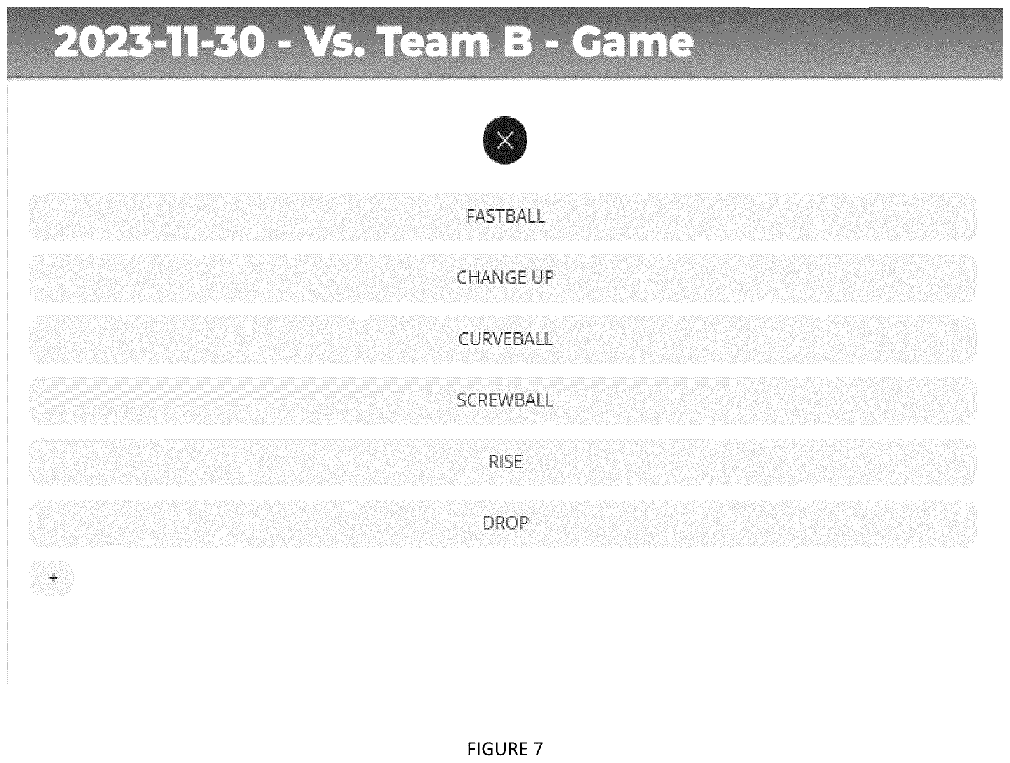

In the practice session, the coach will preferably be positioned behind the catcher, much like an umpire, to view the pitch. The coach can alternatively be located otherwise, as long as he or she can determine the pitch location as it crosses the plate. The coach will have a terminal with them, preferably a touchscreen terminal like an iPad, laptop, or mobile device operating and interacting with the application software. Once the practice session is started, the batter's strike zone pitch page is displayed, as shown in FIG. 6. In the figure, the strike zone represented on the display is selected for the selected game type (softball or baseball). As shown, the strike zone is divided into nine location boxes (more or fewer could be used in other embodiments). Shown on the terminal is the expected pitch in the pitch sequence (which can be changed with one touch, using the pitch type sub-menu). See FIG. 7. Also shown in FIG. 6, on the right hand side of the screen are the statistics from the previous pitches in the practice session for the pitch type. This information is updated in real time for each subsequent pitch. As used herein, “real time” indicates that the displayed information is updated with the current pitch information before the next pitch is thrown. Currently, this type of information is not readily available to the coach in real time. If the displays indicate to the coach that something serious is wrong with the pitching, the coach can interrupt the pitching session, and show the displays to the pitcher as a teaching technique to help the pitcher correct his pitching technique.

In the session, the coach will relay the pitch to the pitcher, or the catcher can signal the pitch to the pitcher. The pitcher will then throw the designated pitch, and the coach will indicate on the batter's strike zone page on his display terminal where the pitch crossed the strike zone. Note, the pitch may cross the plate above, below, or to one side of the strike zone, and the coach will so indicate. Preferably, the terminal has a touchscreen, so the coach can simply touch the location of the pitch crossing the plate area on the batter's strike zone page. The coach will then call the pitch as a strike or a ball, and the call (the pitch result) is entered into the user terminal and stored in the system databases. For instance, a pitch may be in the strike zone or outside of the strike zone and could be called a ball. If the practice session is to practice pitch location, such as fastball low and inside, a pitch in the two bottom rows, and in the last two columns of the batter's strike zone may be designated as a strike, and pitches elsewhere, even elsewhere in the strike zone, would be designated as balls.

For each pitch, the system records the practice identifier, the pitcher, and the pitch attributes (e.g., the selected pitch type and the thrown pitch location, as specified by the coach touching the location on the displayed batter's strike zone), and the pitch result as a ball or strike, as selected by the coach from the pitch result page. These pitch attributes are recorded in the Team practice databases. In another embodiment, a speed gun may be interfaced to the system, such as with Bluetooth or Wi-Fi, and the pitch speed can be recorded in the database as an additional pitch attribute.

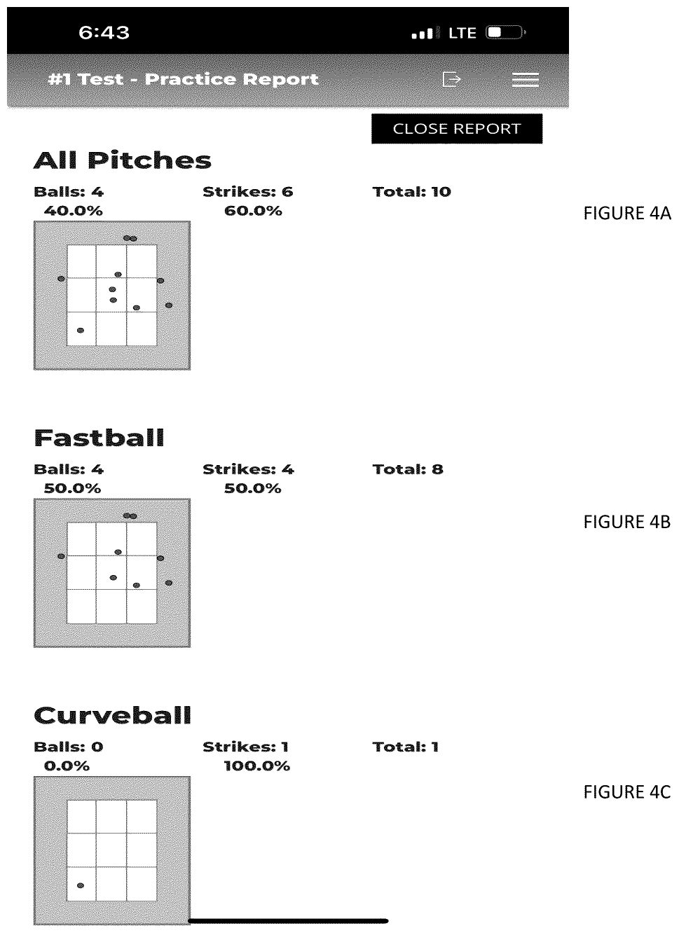

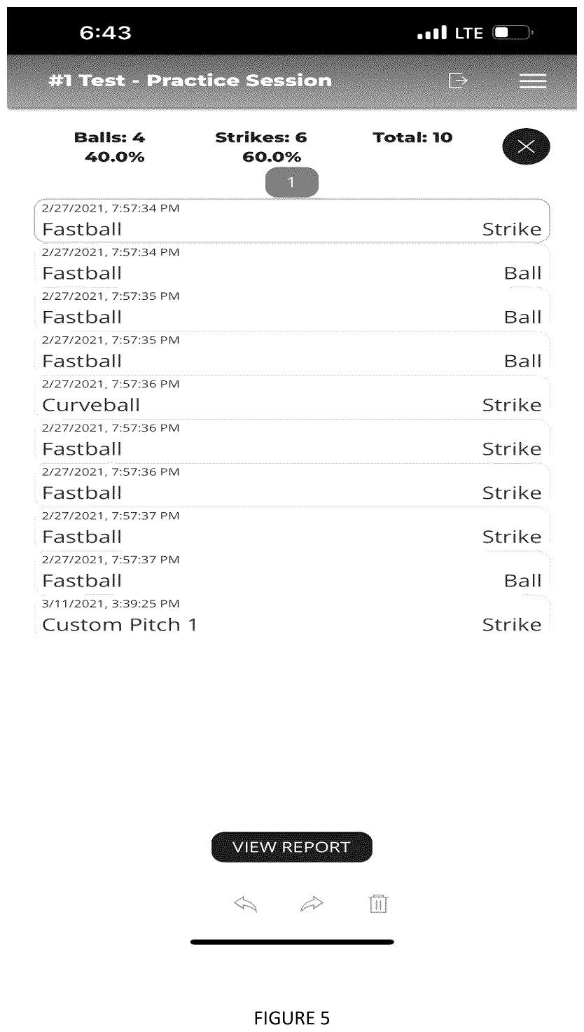

The coach can then use this stored information to evaluate the pitcher's performance, either in real time, using the pitch statistics shown in FIG. 6, or in a postmortem practice session. A performance tab can be activated from which statistics from a particular practice session can be organized and displayed; one possible method of organization is by location of pitches in the batter's strike zone (see FIGS. 4A, 4B and 4C). Pitch location is displayed in a bare strike zone box. Pitches may also be displayed in a table-type display (see FIG. 5), a box chart, or other selectable formats. For instance, a pitcher's performance on curveballs can be extracted from multiple practice sessions and the raw data displayed, or the data can be plotted by sessions to enable the coach to evaluate the pitcher's performance over time, or the prior sessions may be statistically analyzed to show pitching performance, such as by determining the percentages of strikes of each pitch type for each session and plotting such. Both real time and postmortem evaluations can be used by the coach as a teaching tool to help the pitcher modify his or her pitching technique to achieve the desired pitch type and/or pitch location.

### Game Mode

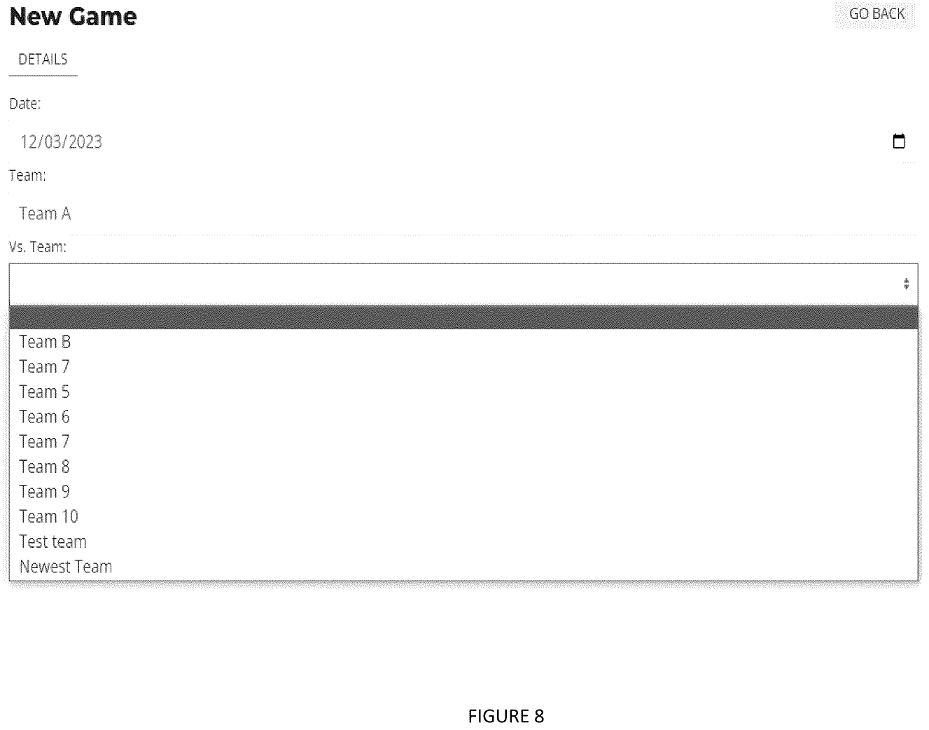

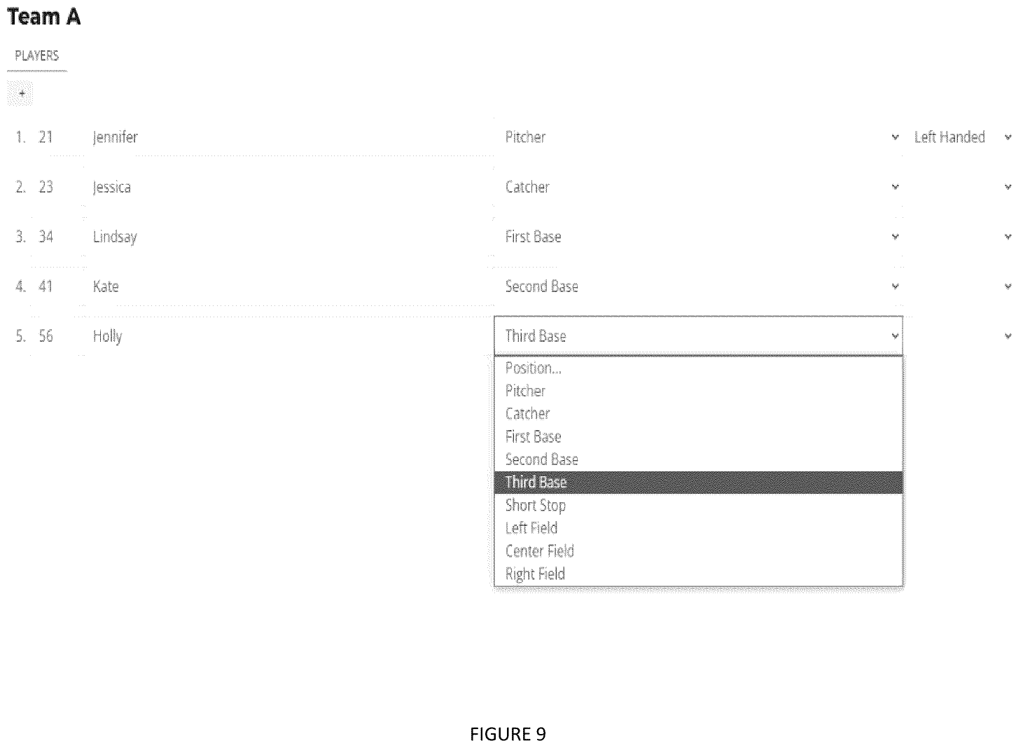

The Game Mode is used to track pitches to evaluate the pitcher's performance during an actual game. Game Mode creates a record of every pitch and the results of that pitch and allows the interactions between a pitcher and batter to be displayed and analyzed in real time during the game. Game Mode offers reports for the pitch statistics and play outcomes through tables, strike zone charts, and spray charts. The game is set up by selecting the Game tab on the system dashboard, where the user enters identifying details of game to be played, such as opposing team name, game date, game type (baseball or softball), and to designate which team is the home team. See FIG. 8. If the team to be played is a new team, the Team tab is selected in the Dashboard, which activates the Team page menu page (see FIG. 9). On this page, the user would input the new team information, such as team name, the team roster, (including pitchers and the handedness of the pitcher), player positions, and batting order (not shown). Note, the Roster button on the dashboard brings up a similar page for the entry of the details of the coach's team. If the opposing team's roster and batting order is not known in advance, this information can be entered in the running Game Mode interactively as the game progresses. The players' information can be identified by each player's name, if available, or each player's jersey number. As an option, the umpire may be identified for the game.

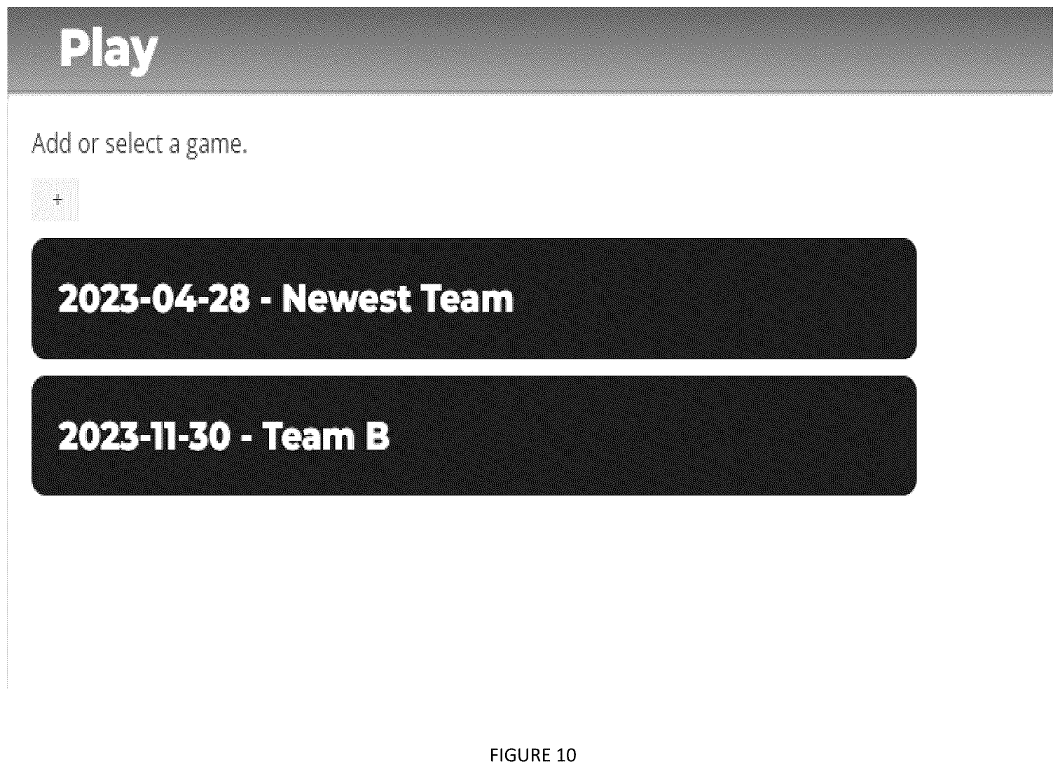

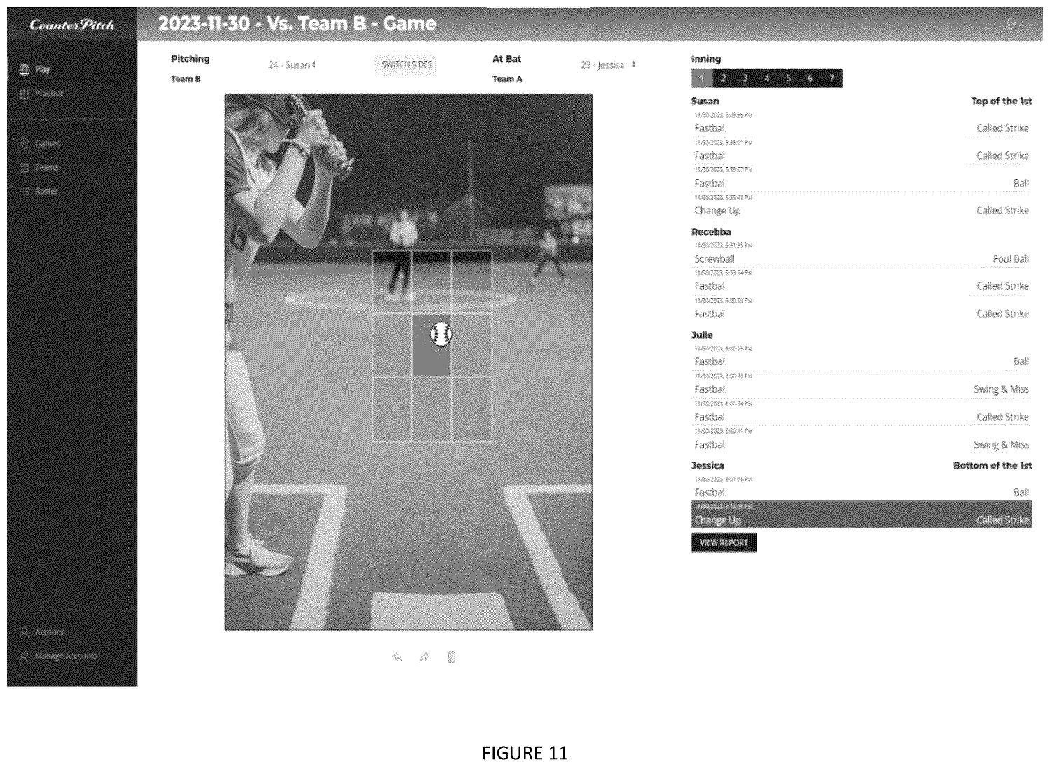

Once the Game Mode is set up, and the game is ready to begin, the start button is hit from the Dashboard, and the user identifies the game to be played. See FIG. 10. Once the game is selected, the system starts the Game Mode, showing the batter's strike zone on the left hand side of the screen, and on the right hand side is shown the actual results of pitching throughout the game, and for the current inning, populated pitch by pitch in real time. See FIG. 11. Shown in this figure on the right side of the screen are the results for the first inning, identifying the batting team, the batters, the pitch sub-sequence of pitches or pitch history, for each batter (e.g., the players' batting history in the inning), and the pitch result for each batter for the team in the first inning. This interactive display during the inning is filled out or populated by the system, pitch by pitch in real time for the recorded pitch attributes for each pitch in the batter's sub-series. This information can be used by the coach to modify or select the next pitch to the current batter.

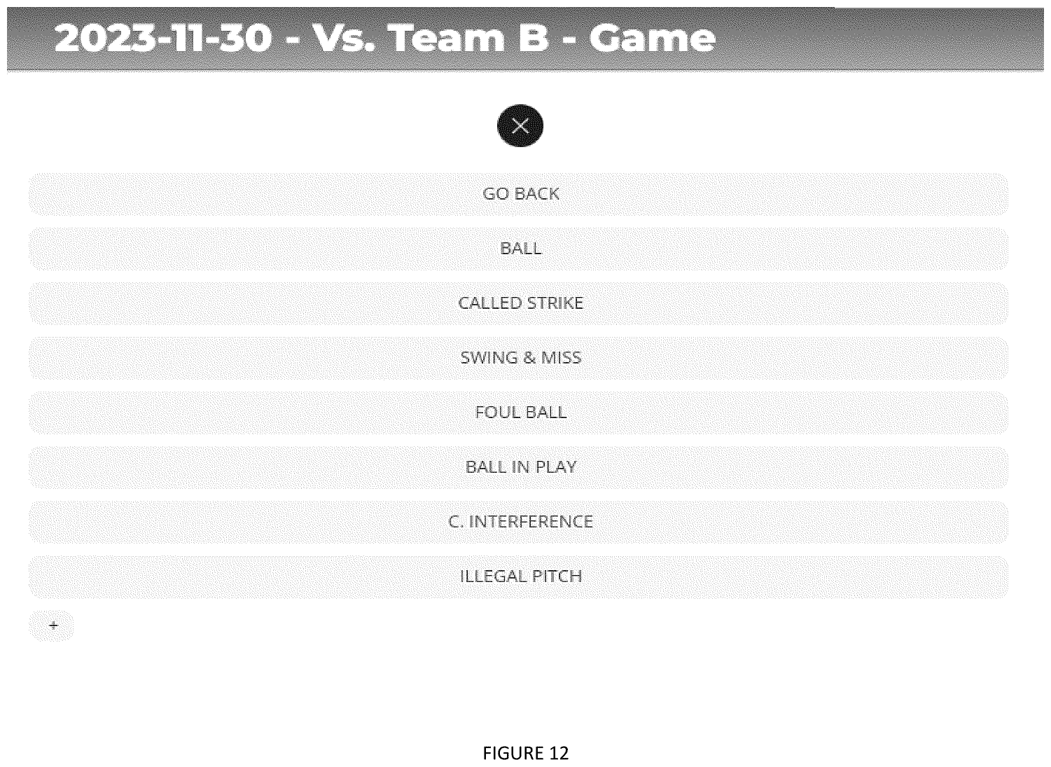

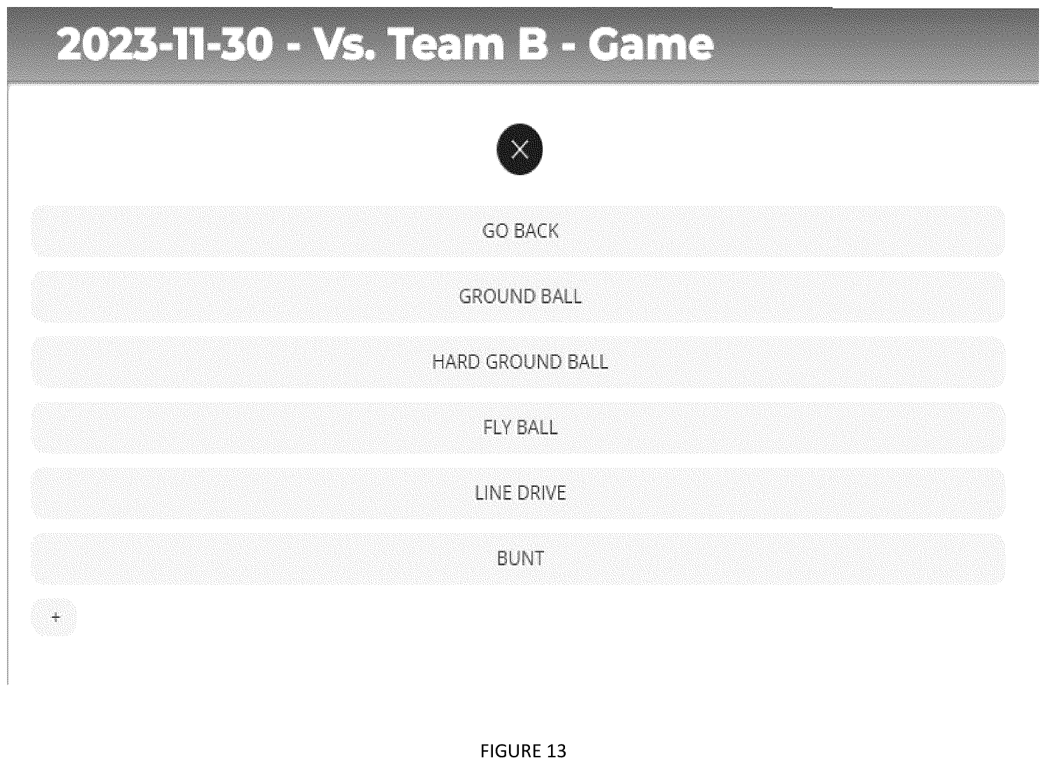

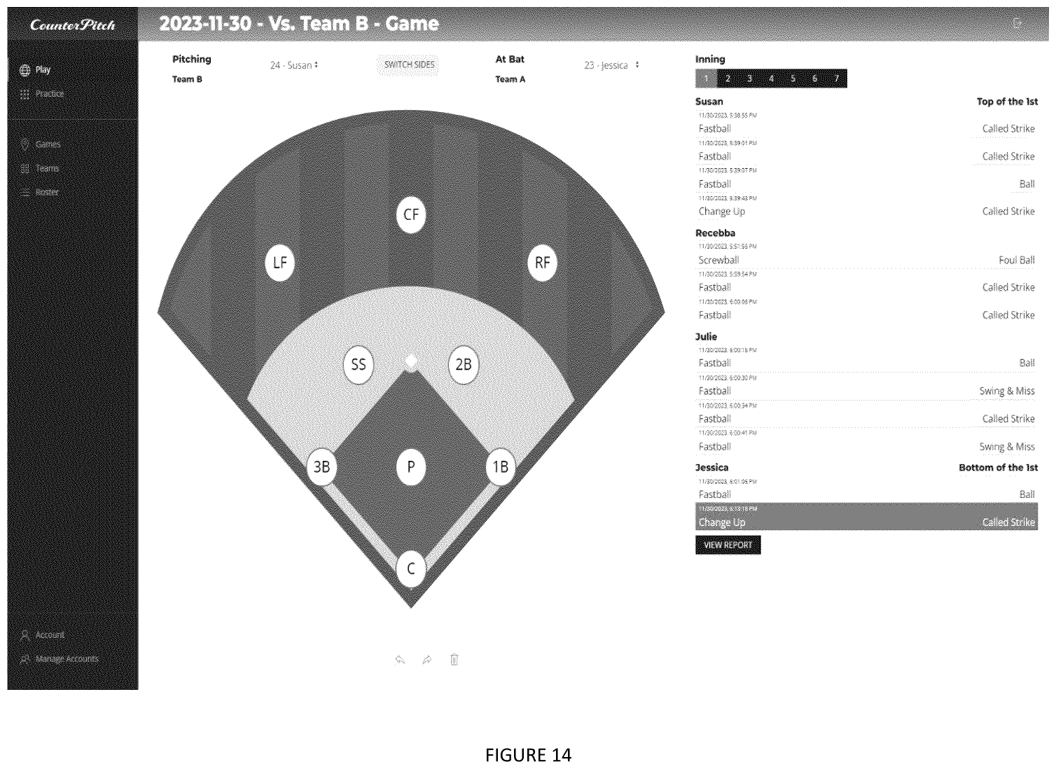

For a batter in the hitting order, if his identifying information is not entered in the team definition table, then when the batter comes to bat, the user can enter his identifying information (by jersey number, for instance). Once a pitch is made, the coach will locate on the batter's strike zone of FIG. 11 where the pitch crossed the plate by touching where the ball appeared in the strike zone display, either within the strike zone, or outside the strike zone. This location selection will then initiate the pitch type menu page (see FIG. 7) where the coach will select the pitch type as determined by the coach (fastball, curveball, etc.) and that selection will then cause the pitch results menu page to be displayed (see FIG. 12) where the user will select the pitch result (e.g., strike or ball, as called by the umpire). If the “ball in play” option is selected from this menu, this selection indicates that the pitch was hit by the batter, and the hit results menu page is then displayed (FIG. 13), from which the user selects the hit result (single, double, foul ball, etc.). Once selected, in one embodiment, the system will then display a schematic of the ballpark playing field (see FIG. 14), on which the coach will indicate the location to where the ball was hit by touching the spot on the screen that best approximates the location of the hit ball. Note that the defensive players are also shown on this figure, for instance center fielder (CF), pitcher (P), etc., and the user may also indicate which defensive player tried to make a play on the ball by touching the player symbol, or moving the player symbol to the hit location. Note in this series of actions, a selection on one page automatically displays the next page in the pitched ball attribute sequence. This is needed as the time between pitches is short, and the automatic sequence of pages allows the coach to enter the appropriate information on each pitch quickly, so updated information can be displayed in real time.

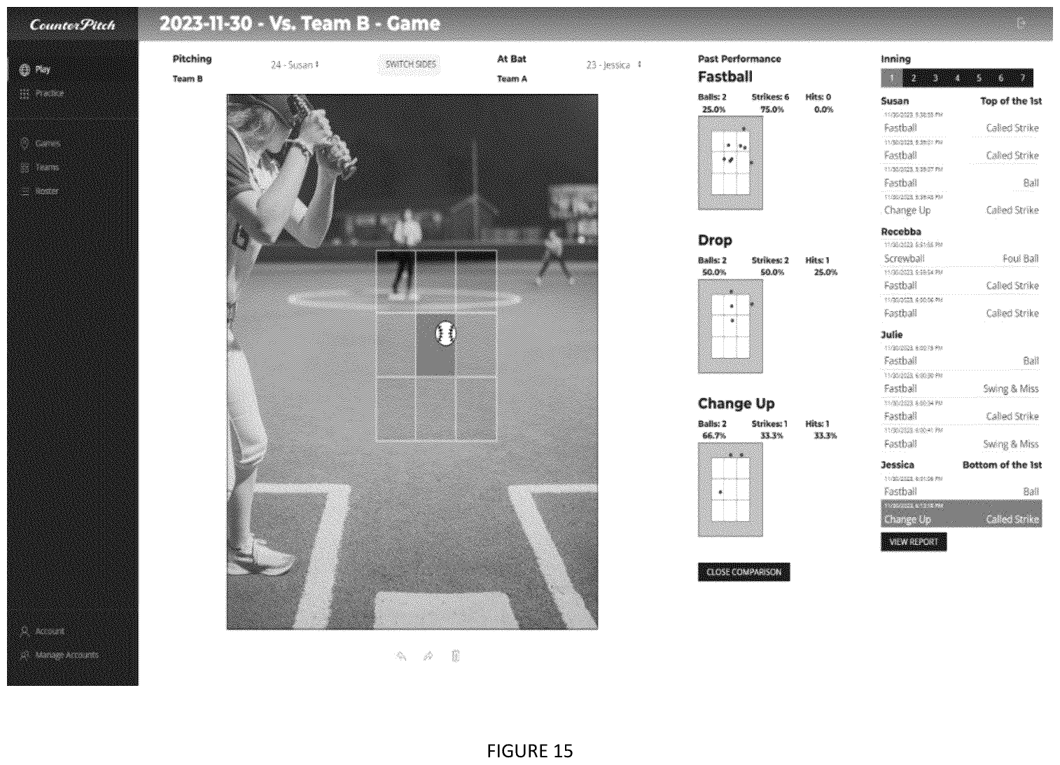

If a batter appears a second or third time in a later inning (or multiple times in a single inning), the user may optionally select to show what previous pitches were made to the batter and the results of those pitches. See FIG. 15, where the pitch type, pitch location, % strikes, % balls, and % hits are shown for previous pitches to this batter, as shown in the middle column on the screen. The previous pitch locations are displayed in a bare strike zone box for each pitch type. This can be helpful to the coach in calling a pitch or pitch sequence to the batter.

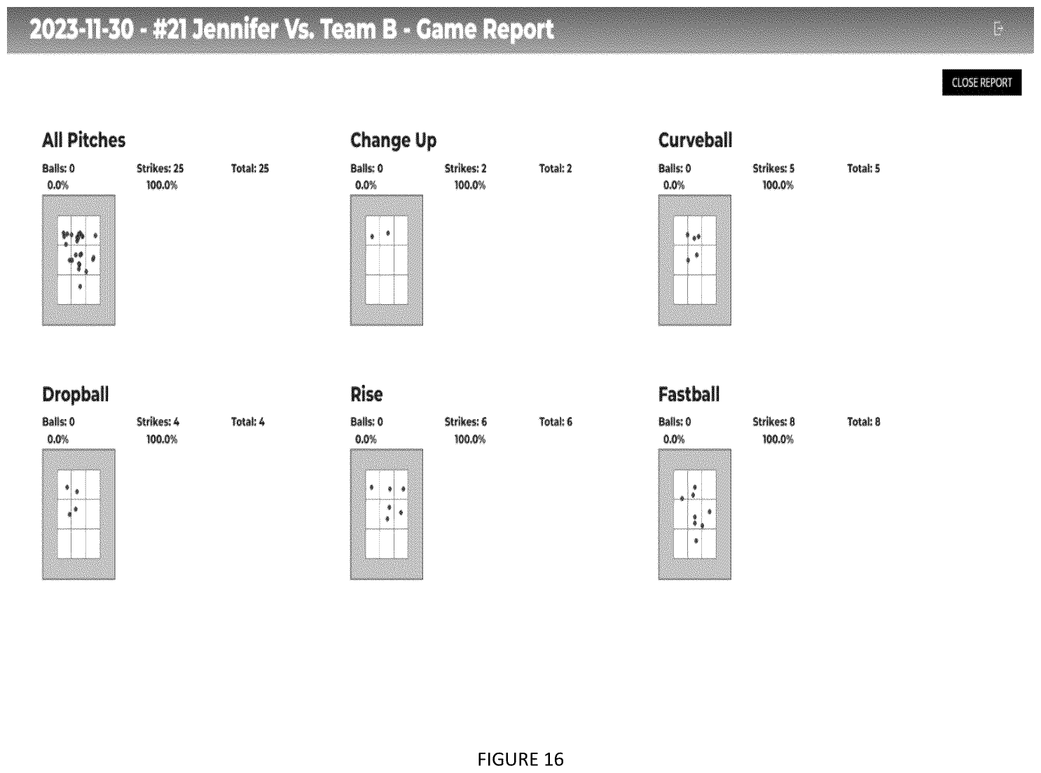

At the completion of the game, the pitching performance can be analyzed. For instance, FIG. 16 details the pitching performance shown by pitch type, pitch location % balls, % strikes and % hits. Other types of pitch analyses can be constructed from the recorded game attributes in the system databases. As a database, results from a database query can be pulled and displayed in multiple fashions. For instance, game pitch results can be compared to previous historical records during and after a game, such as by comparing the pitch performance in the instant game with previous pitch performance in prior games. These reports may be optionally made available to the pitcher with their own authorized log-in account or by email. As another example, the called strikes and called balls for the entire game can be displayed, or for the game up to the instant time, to help determine the umpire's strike zone. The possibilities are endless. This data can be accessed through the Reports tab in the Dashboard, allowing the coach to build a database query and select how the results of the query should be displayed.

The coach can also use Game Mode to track pitches pitched to his team's players to track their hitting performance. Other embodiments may include an entry to show players on base during a pitch, as this can significantly alter pitch strategy. The Game Mode includes the ability to change pitchers during the game, where the new pitcher's pitch results are treated separately (e.g., in a separate table) from the original pitcher's results.

Note that the menus shown are for a laptop or large tablet display. The menus will look different in a mobile application due to the limited screen size on a mobile device.

As noted, the analysis of pitch performance for pitches in Practice Mode or Game Mode can be done in real time, or postmortem. Analysis for past games and practices can also be undertaken before a practice session or game to allow the coach and pitcher to prepare for the upcoming session or game, similar to football players watching film of prior games.

1. System for tracking pitches in a baseball or softball setting, the system comprising a user device with an display, the system further comprising application software and associated databases, the application software displaying on the user display an image of a batter's strike zone, where the application is configured to receive, for each pitch in a series of pitches from a pitcher, (i) a location of each pitch, where the location is selected by a user on the displayed image of the batter's strike zone, where the location selected by the coach represents where the pitch crosses a plate, either inside or outside of a strike zone, and (ii) a series of entries selected by the user representing attributes of the pitch, said attributes entered on the user device by the use and recorded in the system databases, said attributes comprising a pitch type and a pitch result;
where the system records in the system databases, for each pitch in a series an identifier of the pitcher, and the attributes of the pitch; where the system will display the recorded pitch information on the device in real time, pitch by pitch.

2. The system of claim 1 where the system has a practice mode where the series of pitches comprising the practice session are all of the same pitch type.

3. The system of claim 2 where for each pitch in the practice session, prior to the pitch, the system displays on the interactive screen a bare strike zone box showing the location of all prior pitches in the practice session and providing pitch statistics for the prior pitches in the practice session, where the pitch statistics comprises the strike percentages and ball percentages of those prior pitches, and where the pitch statistics information is updated immediately after each subsequent pitch. with the addition of the subsequent pitch location and pitch result.

4. The system as in claim 1 where the system has a game operating mode where the series of pitches represents pitches to batters on team in a number of innings.

5. The system in claim 4 where for each pitch in a current inning, the system displays a list of prior pitches in the current inning, where the list identifies, for each prior batter in the current inning, and a sub-series of pitches to each prior batter, representing the batter's batting history in the inning, and lists identifies of the pitch type and the pitch result for each pitch in the sub-series.

6. The system of claim 5 wherein when a batter comes up to bat a second or third time, the system displays a series of bare strike zone boxes, one for each type of pitch presented to the batter in earlier at bats, where the bare strike zone box shows the locations of prior pitches and the percent of strikes of the prior pitches and percent of balls of the prior pitches for the pitch type are listed.

7. The system of claim 1 where the system includes a report mode, where the system will receive a database query from the user, and the system execute the database query on the recorded information in the databases, and where the system presents the results of the database query in a pre-selected display format on the user's display.

8. A method of tracking pitch accuracy in real time comprising for each pitch, recording the pitch location, pitch type, and pitch result and hit result if present in an electronic database, and displaying for each pitch type, the location of all prior pitches by pitch type, and displaying the percent of prior pitch types that were strikes, and the percentage of all prior pitches of that pitch type that were balls, and the percentage of all prior pitches of that pitch types that were hits, and updating these pitch type displays in real time with the results of each subsequent pitch.

9. The method of claim 8 where in a game, the pitch type displays are presented for the prior pitches to the current batter.

10. The method of claim 9 where the batter pitch type displays are used by the user to select the pitch type and/or pitch location of the next pitch to that batter.

11. The method of claim 8 where the pitches are performed by a pitcher in a practice session, where all pitches are of the same type, and where the recorded information for prior pitches in a pitch session are displayed to show the location of all prior pitches, the percentage of all prior pitches that were strikes and the percentage of all prior pitches that were balls and updating this display in real time with the results of each subsequent pitch.

12. The method of claim 11 where the displayed information is used by the user to interrupt the practice session to correct the pitcher's pitching technique.
